(19) United States
(12) Patent Application Publication
(10) Pub. No.: US 2023/0181995 A1
(43) Pub. Date: Jun. 15, 2023

(54) In-Activity Visualizations for Exercise Devices

(71) Applicant: Echelon Fitness Multimedia LLC, Chattanooga, TN (US)

(72) Inventors: Lou Lentine, Stuart, FL (US); John Santo, Orlando, FL (US)

(21) Appl. No.: 18/080,840

(22) Filed: Dec. 14, 2022

Related U.S. Application Data
(60) Provisional application No. 63/289,543, filed on Dec. 14, 2021.

(51) Int. Cl. A63B 71/06; A63B 24/00

(52) U.S. Cl. CPC A63B 71/0622; A63B 24/0062; A63B 24/0084; A63B 71/0669; A63B 2024/0096; A63B 2071/0644

(57) ABSTRACT

Various improvements in fitness devices are disclosed. In an embodiment, a method is disclosed including reading performance data from an exercise device; adjusting a visual output of one or more visual output devices (VODs) attached to a mechanical element of the exercise device; and synchronizing the visual output of the one or more VODs in response to a change in the performance data.

### BACKGROUND

Exercise devices have become an increasingly popular means for users to exercise in engaging and competitive settings. Most recently, many such devices have been designed for and installed in residences, hotels, or similar settings. Further, such devices often rely on complex software and graphical user interfaces to present data recorded by the exercise devices and, in some scenarios, synchronized with other devices.

However, visual displays of data on exercise devices present unique challenges not found in other realms of visual displays. Specifically, users are inherently not fully able to engage with a visual display as much as, for example, a stationary user of a laptop or desktop computer can engage with a visual display. That is, users performing fitness activities are, for example, often focused on exercising, unable to physically interact with a computing device, out of breath, or unable to hear (e.g., due to the playing of music via personal audio devices) during fitness activities. Even when not engaging in physical activities, users are frequently not in comfortable positions to interact with an input device. For example, users on stationary bikes are generally in a position to exercise and may not be able to perform extensive user interface operations (e.g., touch operations) without significant effort. Thus, in general, users interacting with visual displays or other computing devices on exercise devices are generally ill-equipped for complex interactions.

Many existing solutions attempt to compensate for this temporarily lowered ability by reducing the functionality of visual displays. For example, large user interface elements are used to enable coarse touch inputs, and few screens are presented to avoid physical exhaustion during interactions. However, such approaches fundamentally reduce the amount and quality of information that can be presented to users of exercise devices.

### BRIEF SUMMARY

The example embodiments remedy these and other problems by providing various embodiments for providing visual displays and receiving user input while users are interacting with exercise devices (e.g., stationary or spin bikes, rowing machines, treadmills, etc.). The example embodiments solve existing technical problems in the art of computer displays attached to exercise devices and enable complex user interactions despite a challenging user environment.

In some aspects, the techniques described herein relate to a method including: reading performance data from an exercise device; adjusting a visual output of one or more visual output devices (VODs) attached to a mechanical element of the exercise device; and synchronizing the visual output of the one or more VODs in response to a change in the performance data.

In some aspects, the techniques described herein relate to a method, wherein reading performance data includes reading one or more of a speed, power, resistance, elevation, cadence, or split time.

In some aspects, the techniques described herein relate to a method, wherein adjusting the visual output of the one or more VODs includes categorizing the performance data and identifying an output value of the VODs based on a categorization of the performance data.

In some aspects, the techniques described herein relate to a method, wherein adjusting the visual output of the one or more VODs includes adjusting a brightness of the VODs.

In some aspects, the techniques described herein relate to a method, wherein adjusting the visual output of the one or more VODs includes adjusting a color of the VODs.

In some aspects, the techniques described herein relate to a method, wherein adjusting the visual output of the one or more VODs includes selectively adjusting the VODs to form a pattern.

In some aspects, the techniques described herein relate to a method, wherein adjusting the visual output of the one or more VODs includes toggling the VODs at a rate based on the performance data.

In some aspects, the techniques described herein relate to a method including: loading a set of scenic activities, a given scenic activity in the set of scenic activities including a set of intervals, each interval in the set of intervals including a video segment and one or more parameters associated with an exercise device; adjusting, by a user, an ordering of the set of scenic activities; and adjusting, by the user, at least one parameter of at least one interval associated with a respective scenic activity in the set of scenic activities.

In some aspects, the techniques described herein relate to a method, wherein the set of scenic activities include a set of video segments, the set of video segments obtained by segmenting a video a location.

In some aspects, the techniques described herein relate to a method, wherein adjusting the ordering of the set of scenic activities one of adding, removing, or rearranging intervals in the scenic activity.

In some aspects, the techniques described herein relate to a method, wherein adjusting the at least one parameter includes adjusting one or more of a speed, power, resistance, elevation, cadence, or split time for the at least one interval.

In some aspects, the techniques described herein relate to a method, further including playing back the set of intervals while the user operates the exercise device.

In some aspects, the techniques described herein relate to a method, wherein playing back a given interval in the set of intervals includes playing back a video segment associated with the given interval and adjusting the operation of a mechanical component of the exercise device based on a parameter associated with the given interval.

In some aspects, the techniques described herein relate to a method, further including saving the adjusted set of scenic activities.

In some aspects, the techniques described herein relate to a method including: displaying a video on a display of an exercise device, the video including a plurality of frames, at least one frame in the plurality of frames including a defined hotspot; detecting that a user interacted with the defined hotspot while using the exercise device; identifying an activity type based on the defined hotspot; and launching the activity while the user uses the exercise device.

In some aspects, the techniques described herein relate to a method, wherein the activity type includes a shopping activity.

In some aspects, the techniques described herein relate to a method, wherein the activity type includes a trivia activity.

In some aspects, the techniques described herein relate to a method, wherein the activity type includes a game activity.

In some aspects, the techniques described herein relate to a method, wherein the activity type includes a racing activity.

In some aspects, the techniques described herein relate to a method, wherein the activity type includes a multi-player activity.

In some aspects, the techniques described herein relate to a method including: initiating an on-demand fitness activity with a cohort of users; recording performance data associated with each user in the cohort of users; and generating a plurality of leaderboards based on the performance data, a first leaderboard in the plurality of leaderboards including the cohort of users and a second leaderboard in the plurality of leaderboards including a global set of users.

In some aspects, the techniques described herein relate to a method, further including selecting the on-demand fitness activity and inviting one or more users to form the cohort of users.

In some aspects, the techniques described herein relate to a method, wherein the global set of users includes a set of users including users not in the cohort of users that have previously participated in the on-demand fitness activity.

In some aspects, the techniques described herein relate to an apparatus including a processor configured to perform the foregoing methods.

In some aspects, the techniques described herein relate to a non-transitory computer-readable storage medium for tangibly storing computer program instructions capable of being executed by a computer processor, the computer program instructions defining the steps of the foregoing methods.

### BRIEF DESCRIPTION OF THE FIGURES

FIG. 1 is a block diagram illustrating a fitness system according to some of the example embodiments.

FIG. 2 is a flow diagram illustrating a method for varying the visual output of an exercise device according to some of the example embodiments.

FIG. 3 is a flow diagram illustrating a method for generating a scenic exercise class according to some of the example embodiments.

FIG. 4 is a flow diagram illustrating a method for providing embedded functionality in a fitness activity according to some of the example embodiments.

FIG. 5 is a flow diagram illustrating a method for generating a scheduled on-demand fitness activity according to some of the example embodiments.

FIG. 6 is a block diagram of a computing device according to some embodiments of the disclosure.

### DETAILED DESCRIPTION

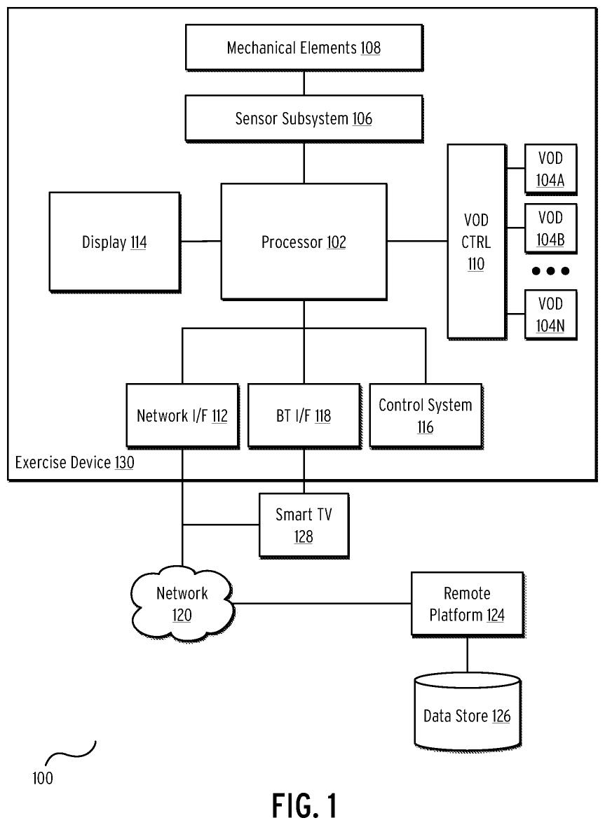

FIG. 1 is a block diagram illustrating a fitness system according to some of the example embodiments.

In an embodiment, a system 100 includes an exercise device 130. The exercise device 130 may include a plurality of mechanical elements 108. The specific mechanical elements 108 of exercise device 130 are not limiting, and various different types of exercise devices may include different mechanical elements 108. For example, a spin or exercise bike may include a flywheel or types of resistance elements. A rowing machine may include a fan or other type of resistance element. A treadmill may include a motor or similar device. Mechanical elements 108 may include additional elements such as physical controls (e.g., handlebars), structural elements, or other types of physical devices. While the following embodiments describe selected physical elements in more detail, any such discussion is not intended to be limiting.

As illustrated, exercise device 130 can include various electronic components. In an embodiment, the exercise device 130 includes a processor 102. The processor 102 can comprise a central processing unit (CPU), graphics processing unit (GPU), microcontroller, or another type of processing device. In some embodiments, the processor 102 can include multiple such processing devices. In some embodiments, the processor 102 can read data from memory or disk (e.g., non-transitory computer-readable storage media) and execute computer program instructions stored thereon. Details on the operation of such operations are provided in the following flow diagrams.

In an embodiment, the processor 102 can receive data from mechanical elements 108 via sensors 106. In an embodiment, sensors 106 can be equipped for any desired mechanical element. For example, a sensor can be figured to monitor a resistance level of a flywheel (e.g., in a spin or exercise bike) or a fan or water container (e.g., in a rowing machine). In an embodiment, sensors 106 generate continuous or periodic data points representing the mechanical state of the exercise device 130 and provide these data points to the processor 102. In some embodiments, processor 102 can receive the data point via a designated interface (e.g., a Peripheral Component Interconnect Express, PCIe, bus, serial peripheral interface bus, etc.). In an embodiment, the sensors 106 can include a weight or pressure sensor. In such an embodiment, the weight or pressure sensor can detect the use of the exercise device 130 by a user. For example, a spin or exercise bike can include such a weight or pressure sensor in a seat element or pedal element to detect when a user is sitting or otherwise engaging with the exercise device 130. Similarly, a treadmill device can include a weight or pressure sensor along the tread to identify when a user is using the exercise device 130.

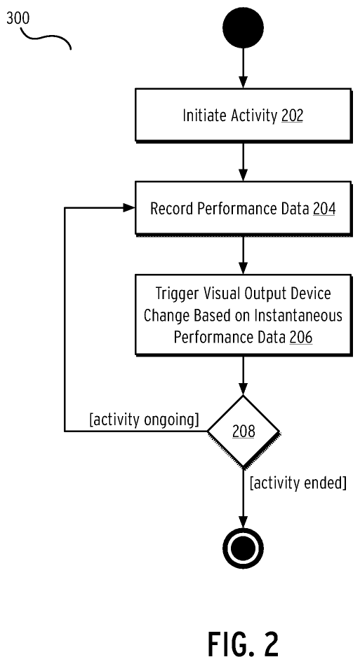

In an embodiment, the exercise device 130 can include a plurality of visual output devices (VODs) such as VOD 104A, VOD 104B, and VOD 104N. In an embodiment, these VODs can comprise a device providing visual output to users. For example, a VOD can comprise a light-emitting diode (LED) or similar light-generating device. In some embodiments, the VODs can be attached to various parts of the exercise device 130, including one or more of the mechanical elements 108. For example, the VODs can comprise LEDs attached to a wheel or other rotating device of the exercise device 130. In some embodiments, the VODs can be electronically controlled. In some embodiments, each VOD (e.g., VOD 104A, VOD 104B, VOD 104N) can be communicatively coupled directly to the processor 102. In another embodiment, the VODs can be managed by an intermediary controller such as VOD controller 110. In some embodiments, the VOD controller 110 can comprise a microcontroller or other lightweight processing unit. In some embodiments, the VOD controller 110 can be coupled to a communications bus. In some embodiments, processor 102 can be configured to transmit signals to the VODs (e.g., via VOD controller 110) to change the state of the VODs. Details of this operation are provided in FIG. 2. In some embodiments, the VODs can be separate from the exercise device 130. For example, one or more VODs can be affixed to external devices (or otherwise independent from the exercise device 130) and can be communicatively coupled to the processor or controller of the exercise device 130 (e.g., via Bluetooth interface 118).

In an embodiment, the exercise device 130 can be controlled via one or more controls in control system 116. In some embodiments, the control system 116 can comprise a plurality of physical control elements. For example, control system 116 can comprise physical buttons or other types of user input elements to control operations of exercise device 130. In an embodiment, the control system 116 can include a plurality of buttons situated on a handlebar or other mechanical element of the exercise device 130. In some embodiments, the buttons can be configured to transmit interrupt signals to processor 102 to trigger an operation by processor 102. For example, one or more buttons on handlebars can be used to change the resistance level of a programmatically controllable mechanical element of the exercise device 130 (e.g., a flywheel, fan, etc.). Other operating parameters (e.g., treadmill speed, elevation, cadence, split time, heart rate target, etc.) can be used. In some embodiments, the buttons can be used to increment or decrement an operating parameter. In other embodiments, the buttons can be used to load a preset setting for the operating parameters. Alternatively, or in conjunction with the foregoing, buttons situated on handlebars can be used to control the volume output of a speaker connected to processor 102 (not illustrated). In some embodiments, the control system 116 can include other types of input devices such as trackballs, trackpads, scroll wheels, etc. In some embodiments, the control system 116 can include multiple, disparate types of input controls. In some embodiments, the control system 116 can include a voice control system that includes a microphone and speech processor to convert audio into text commands. In some embodiments, a voice control system can be used to allow users to adjust settings of the exercise device 130 (e.g., resistance, incline, etc.) without requiring manual input.

In an embodiment, the exercise device 130 includes a display 114. In some embodiments, display 114 can comprise a flat panel display. In some embodiments, the display 114 can comprise a curved flat panel display. In some embodiments, the display 114 can comprise an organic LED (OLED) display or a similar type of display. In some embodiments, display 114 can be communicatively coupled to the processor 102 via a standard video connection and bus. In an embodiment, the processor 102 can be configured to generate graphics to display on display 114. For example, processor 102 can present user interfaces to a user of the exercise device 130 during operation, as will be discussed in more detail herein.

One example of a user interface comprises a video of an exercise class that can be synchronized and streamed to multiple exercises devices. In some embodiments, the video can be filmed by recording an instructor using an exercise device and then replayed to multiple exercise devices along with operating parameters to use for the exercise devices. In some embodiments, the instructor can be filmed in front of a large screen (e.g., LED display) or another display device that can display content. In some embodiments, this content can comprise music videos or similar types of content.

In an embodiment, the exercise device 130 includes a Bluetooth interface 118 for communicating with nearby electronic devices. In an embodiment, the Bluetooth interface 118 can comprise a device implementing an IEEE 802.15.1 standard or similar short-range wireless technology standard. In an embodiment, the exercise device 130 can communicate with other display devices such as a smart television 128 via the Bluetooth interface 118. In some embodiments, the exercise device 130 can transmit operating data recorded by sensors 106 to the smart television 128. In response, the smart television 128 can update a display based on the data recorded by sensors 106. For example, the smart television 128 can display a fitness activity with real-time data recorded by sensors 106 as well as data recorded by sensors of other exercise devices. Details of communication between exercise device 130 and smart television 128 are provided in more detail in commonly-owned application bearing Attorney Docket No. 178139-800250. In some embodiments, the exercise device 130 can use the Bluetooth interface 118 to communicate with other types of devices, such as mobile phones or tablets.

In an embodiment, the exercise device 130 can include a network interface 112 to connect to one or more communications networks 120. In an embodiment, the one or more communications networks 120 can include a public Internet or similar type of wide-area network (WAN). In some embodiments, the one or more communications networks 120 can include a local area network (LAN) in addition to (or in place of) a WAN.

In some embodiments, exercise device 130 can communicate with a remote platform 124. In some embodiments, the remote platform 124 can comprise one or more physical or virtual server devices or other computing devices that can receive data recorded by the exercise device 130 and provide data to the exercise device 130. For example, the remote platform 124 can receive operating data captured by sensors 106 and synchronize this data with other exercise devices. For example, the remote platform 124 can provide a streaming or on-demand fitness activity to a set of exercise devices and receive the operating parameters of each device. The remote platform 124 can then broadcast all received data to each exercise device to provide a leaderboard or similar type of visualization. Examples of such visualizations (and the operations of remote platform 124) are provided in commonly-owned applications bearing Ser. Nos. 63/177,716 and 17/377,552.

In an embodiment, the remote platform 124 can store centralized data in data store 126. Examples of centralized data include user account data, fitness activity data (e.g., exercise class video data, segment data, etc.), as well as historical operating parameter data associated with the performance of fitness activities. The data store 126 may comprise one or more databases or other types of data storage devices.

The exercise device 130 described above can record the operating parameters of the various mechanical elements 108. The exercise device 130 can also provide a rich visual experience via display 114 (e.g., multi-person classes, leaderboard, streaming video, music, etc.). Various aspects of these operations are described in more detail in the following flow diagrams.

FIG. 2 is a flow diagram illustrating a method for varying the visual output of an exercise device according to some of the example embodiments. In the various embodiments, an exercise device (e.g., exercise device 130) can execute method 200.

In step 202, method 200 can include initiating an activity. In some embodiments, an activity can comprise a fitness class or similar type of activity. In some embodiments, a user can initiate an activity by selecting an activity via a display device (e.g., touchscreen). For example, a user can navigate a listing of fitness activities and select a live or archived fitness activity. In response, method 200 can include transmitting the selection of the activity to a remote platform. The remote platform can load the fitness activity and begin streaming media to the exercise device. Concurrently, the exercise device can stream performance data (e.g., resistance, speed, power, heart rate, elevation, cadence, split time, etc.) to the remote platform, which can synchronize multiple exercise devices and broadcast a group's operating parameters to each exercise device.

In step 204, method 200 can include recording performance data. In some embodiments, the exercise device includes one or more sensors to record such data. For example, the exercise device can include a sensor monitoring the resistance, speed, heart rate, power, elevation, cadence, split time, or other parameters measured by the mechanical elements of the exercise device. In some embodiments, performance data can be streamed from the sensors. In other embodiments, the performance data can be polled periodically. In some embodiments, the performance data can comprise a numerical value recorded by the sensor. In some embodiments, the performance data can comprise data derived from raw sensor measurements (e.g., power). In some embodiments, the performance data can include other types of measurable data. For example, the beats per minute of an audio track playing via a speaker of the exercise device can be used as the performance data.

In step 206, method 200 can include triggering a VOD based on instantaneous performance data.

In an embodiment, method 200 can include converting one or more performance data readings to a signal transmitted to one or more VODs. For example, a speed value can be used to adjust the brightness or light intensity, color, or other visible characteristics of the VODs. In some embodiments, the performance data can be discretized into a plurality of categories, and each category can be associated with a characteristic of the VODs. For example, a speed value can be categorized as fast, medium, or slow, and corresponding brightness values can be used to trigger the VODs. In such a scenario, the VODs can move from low, medium, and bright light as the user's performance data increases from slow to fast. In some embodiments, method 200 can trigger a VOD by adjusting a current or voltage to the VOD. For example, the brightness of a VOD can be adjusted as a function of its input current, and thus method 200 may map categories to input current values.

In some embodiments, method 200 can apply a continuous change to the VOD. Thus, instead of three values (for high, medium, low), method 200 can gradually increase or decrease the value between states to provide a more continuous change in VOD output.

Although brightness is used as an example, the same techniques can be applied for other parameters. For example, method 200 may change a VOD to output red light when the performance data is indicative of a slow speed, yellow light when the performance data is indicative of a medium speed, and a green light when the performance data is indicative of a fast speed. As with brightness, such changes can be continuous as the performance data changes.

In other embodiments, method 200 may perform more complex triggering based on performance data. For example, method 200 can assign various effects to different levels of performance data. As one example, method 200 can vary the blinking rate of the VODs based on performance data (e.g., speed). Thus, when a user is performing at a slow speed, method 200 may toggle (e.g., blink) the VOD output at a slower rate than when the user is performing at a medium or high speed. As with brightness, such changes can be continuous as the performance data changes. In a similar manner, method 200 can vary the color of the VODs based on the categorization of the performance data. For example, various different shades of red can be varied while a user's performance data indicates a slow speed, various different shades of yellow can be varied while a user's performance data indicates a medium speed, etc. Such changes can provide a “sparkling” effect via the VODs.

Further, the rates of all effects can be increased or decreased based on the performance data. For example, revolutions per minute value or stroke speed in an exercise bike or rower (respectively) can be used to determine the rate of change of any effect. In some embodiments, the various effects can be combined. For example, when a user's performance data indicates a slow speed, method 200 can first vary shades of red output by the VODs. Method 200 can also concurrently use a low rate of change for each individual color transition. Conversely, at high speed, method 200 can first vary shades of green output by the VODs. Method 200 can also concurrently use a high rate of change for each individual color transition.

In yet another embodiment, method 200 can generate patterns from multiple VODs. Such patterns can be designed to depict objects, persons, numbers, letters, etc. For example, a pattern can depict a user's current rate of speed (or power output), and that pattern can be displayed by illuminating multiple VODs. In some embodiments, if the structure of the VODs is moving, method 200 can further synchronize the timing of the VODs such that the pattern remains unmoving despite the movement of the underlying structure. In some embodiments, patterns can be defined by the user or can be pre-installed in the exercise device.

In step 208, method 200 can determine if the fitness activity is ongoing. As illustrated, method 200 can continuously execute step 206 (to update the VOD output) while a given fitness activity is being performed. Once the fitness activity ends, method 200 can terminate. In some embodiments, method 200 can terminate by turning the VODs off.

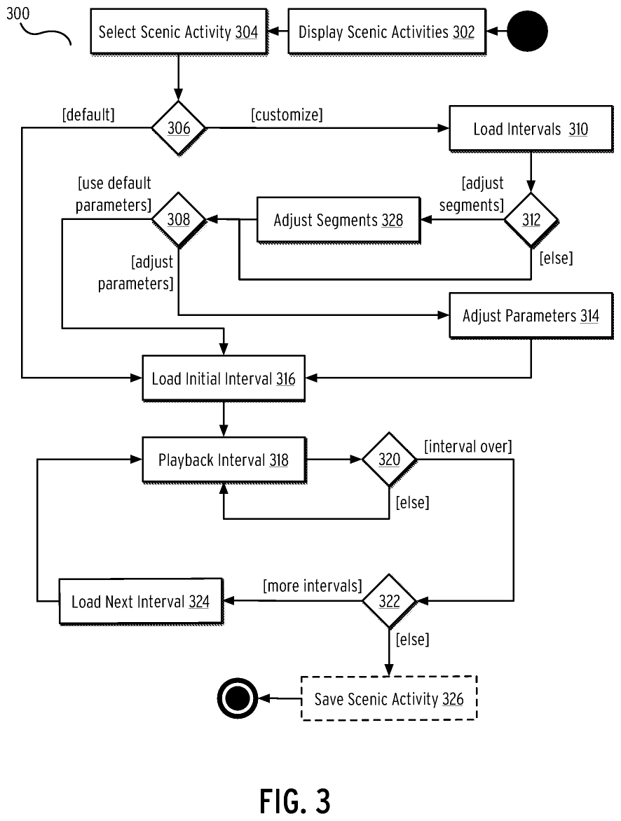

FIG. 3 is a flow diagram illustrating a method for generating a scenic exercise class according to some of the example embodiments.

In step 302, method 300 displays a set of scenic activities. As used herein, a scenic activity refers to a combination of fitness activity and customized video that are linked. As one example, a video of a theme park or other attraction can be recorded. Next, the video can be segmented into one or more video segments. In some embodiments, these video segments correspond to different aspects of the video. For example, a theme park video can be segmented based on rides or other thematic areas in the video. Then, the parameters of a fitness activity can be associated with each segment. A combination of video segment data and parameter data is referred to as an interval. For example, the resistance of a biking fitness activity can be set for each interval. Thus, each interval can be associated with its own parameters. When a user plays back the fitness activity, the video interval can be displayed, and the mechanical components of the exercise device can be configured based on the parameters in the scenic activity interval. As another example, a scenic video can be taken of a mountain trail and segmented based on trail markers along the trail. Then, parameters for each interval can be set to mimic the real-life conditions of the trail.

In step 302, method 300 can include displaying a list of scenic activities. In some embodiments, the initial list displayed in step 302 can be retrieved from a remote platform and can comprise a set of pre-configured scenic activities. That is a set of video intervals and corresponding parameters. In some embodiments, the list of scenic activities can be presented on a display screen attached to an exercise device, such as display 114 discussed in FIG. 1.

In step 304, method 300 can include detecting the selection of a given scenic activity. In some embodiments, each scenic activity displayed in step 302 can be selectable by the user (e.g., via a touch interaction on a touchscreen). Upon detecting user input, method 300 can display a customization screen that allows a user to configure the scenic activity, as discussed next.

In step 306, method 300 can include determining if a user indicates that the scenic activity should be customized. In some embodiments, since the scenic activity includes a set of default intervals and parameter mappings, the scenic activity can be played back and experienced (as described above) without customization. In such a scenario, the user does not indicate a customization, and method 300 can proceed directly to step 316 (discussed herein). However, if the user wishes to customize the scenic activity, method 300 can proceed to step 310.

In step 310, method 300 loads all intervals associated with the scenic activity. As discussed, a given scenic activity can include a plurality of intervals that comprise segmented video portions and parameters controlling the exercise device. In step 310, method 300 can display each individual interval (e.g., as a list of intervals with thumbnails of contents and parameter values) on the display. For example, a theme park activity can include thumbnails including a selected frame for each interval and a summary of the parameter values (e.g., target speed, target resistance, target heart rate, target elevation, target cadence, target split time, etc.) or summaries of parameter values (e.g., “hill climb,” “flat road,” “rest,” “warmup,” etc.).

In step 312, method 300 can include determining if the user indicates that the video segments of the scenic activity should be customized. If so, method 300 can then allow users to adjust the video segments in step 328. In some embodiments, users can indicate that video segments should be customized by adding, removing, or rearranging video segments displayed in step 310. For example, a default scenic activity can include ten video segments out of twenty total possible video segments. In some embodiments, method 300 can allow a user to select any ten video segments out of the twenty to form the scenic activity. For example, a given theme park video may include videos of twenty different rides. A default scenic activity may include five of these rides selected by a human editor. However, in steps 312 and 328, users can customize the scenic activity by replacing or otherwise modifying the video segments included in the ride.

In some embodiments, method 300 can constrain the user's adjustment in step 328 based on the properties of the scenic activity. For example, method 300 can require that exactly five video segments be included in the scenic activity to enable competition with other users performing the same scenic activity.

In some embodiments, when the user adjusts video segments, method 300 can load the new video segment video and any associated parameters of the exercise device. In some embodiments, method 300 can communicate with the remote platform to inform the remote platform of the change and receive the parameters and video segment video (or thumbnail thereof). Thus, when method 300 reaches step 308, a set of desired video segments (and default parameters) are loaded for a scenic activity.

In step 308, method 300 can include determining if the user indicates that the parameters of a given interval of the scenic activity should be customized. If so, method 300 can then allow users to adjust the parameters in step 314. In an embodiment, method 300 can display the adjusted list of video segments (with default parameters) after the user performs the first adjustment in step 328. Then, users can select a given video segment to further refine the default parameters (e.g., resistance level, heart rate target, etc.). In step 314, users can adjust any and all such parameters for each interval.

In some embodiments, method 300 can constrain the adjustments to parameters based on the overall scenic activity or the intrinsic properties of a video segment. For example, a given scenic activity may require an average heart rate between two values, and thus method 300 can limit the user's parameter adjustment to fall within these two values. As another example, a given video segment (e.g., a mountain climbing video segment) can be associated with a specific type of activity (e.g., high resistance), and method 300 can require changes to parameters for such video segments to fall within a fixed range of values to prevent disharmony between the operation of the exercise device and the displayed video segment. In some embodiments, method 300 can consider an overall target when adjusting parameters of individual video segments. For example, a given scenic activity can include a target distance (e.g., ten kilometers), and the parameter adjusted in step 314 can be a per-interval distance. Thus, method 300 can constrain a user's parameter adjustments to require that the total distance equal the target distance.

Once the user has adjusted all desired intervals, or if the user does not wish to adjust any intervals, or if the user opts for the default intervals, method 300 proceeds to step 316.

In step 316, method 300 can load the first interval from the plurality of intervals making up the scenic activity. In some embodiments, intervals in a scenic activity can be arranged in a set order. In some embodiments, this order can be adjusted in step 328. Thus, in step 316, method 300 selects the first such interval.

In step 318, method 300 can include playing back the interval. In an embodiment, method 300 can include playing a video segment associated with the interval and adjusting the mechanical elements of the exercise device based on the parameters corresponding to the interval. For example, while playing back a video segment, method 300 can adjust the resistance of an exercise bike to meet the target resistance represented in the parameters. Alternatively, or in conjunction with the foregoing, method 300 can load a parameter as a target variable (e.g., target heart rate) and monitor sensor data to determine if a user is reaching the target variable.

In step 320, method 300 can include determining if the interval being played back in step 318 is over. If not, method 300 continues to playback the interval in step 318. In some embodiments, an interval is over when a video segment is played until the end of the video segment. Alternatively, or in conjunction with the foregoing, an interval is over when a target parameter is met (either at the moment met or when sustained for a preconfigured time). Other ending conditions may be used. Once the interval ends, method 300 next can include determining if more intervals remain to be played back in step 322. If so, method 300 can include loading the next interval in step 324 and repeating steps 318 and 320 for each remaining interval. Once method 300 determines that all intervals have been played back, method 300 can proceed to optional step 326.

In step 326, method 300 can include allowing a user to save the completed scenic activity. In some embodiments, method 300 can store the ordered set of intervals (including the performance data, adjusted or not) as a user-defined scenic activity. Then, at a later date, method 300 can display the user-defined scenic activity as part of step 302, and users can quickly start user-defined scenic activities without adjustments.

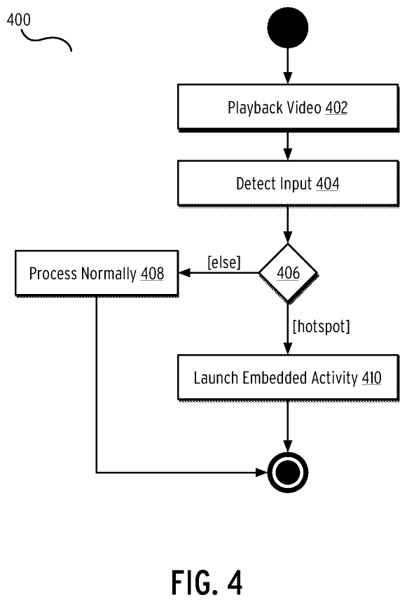

FIG. 4 is a flow diagram illustrating a method for providing embedded functionality in a fitness activity according to some of the example embodiments.

In step 402, method 400 can include playing back a video. In some embodiments, the video can be played back on a display device communicatively (and/or physically) connected to an exercise device. In some embodiments, the video can comprise a fitness activity video. In some embodiments, the fitness activity video can comprise video segments of a scenic activity as described above.

In step 404, method 400 can include detecting input from a user. In some embodiments, the input can comprise a touch input on the display device or a similar type of input. In other embodiments, the input can comprise an input performed using an external control device (e.g., trackball, on-control button, etc.).

In step 406, method 400 can include determining if the input was on a hotspot in the video playing back in step 402. In the illustrated embodiment, a given video can have one or more hotspots associated with frames of the video. As used herein, a hotspot refers to a defined portion of one or more frames. For example, if the video frames depict a monument or other object of interest, a hotspot can comprise a set of edges that encapsulate the monument or other object of interest in each frame. As such, a hotspot can include edges and a set of points encapsulated by the edges. Hotspots, however, are not limited to being linked to objects in video frames. Indeed, hotspots can be generated in arbitrary locations. Further, in some embodiments, computer-generated graphics can be overlaid on top of recorded video, and hotspots can be applied to these computer-generated graphics. For example, a button or other control can be overlaid on the video, and a hotspot can be created for the button.

In some embodiments, hotspots can be generated manually by human editors on individual frames. In some embodiments, editors can generate a single hotspot and apply the single hotspot to multiple frames. In some embodiments, editors can generate a single hotspot for one frame and adjust the edges of the hotspot for other adjacent frames. In other embodiments, hotspots can be identified automatically. For example, an object detection model (e.g., neural network or deep learning network) can be used to perform bounding box recognition of objects. In some embodiments, human editors can receive the predicted bounding boxes and edit or remove bounding boxes as desired to make final hotspots in a video.

In step 406, all user input on a display is recorded. Specifically, in some embodiments, a video can be overlaid with other types of controls. For example, menu controls or leaderboard controls during a fitness activity can be presented. Thus, in the illustrated embodiment, a determination is made as to whether a given user input is associated with a hotspot or not. In some embodiments, method 400 can compare the coordinates of the user input (e.g., in a touchscreen environment) to the defined hotspots displayed at the time of input. If the coordinates fall within a defined hotspot, method 400 will proceed to step 410. If, however, the coordinates do not fall within a defined hotspot, method 400 can proceed to process the input normally in step 408. For example, if the user selects a control element, method 400 can proceed to respond to that selection and display a control panel or other type of interface.

In step 410, method 400 can include launching an embedded activity based on a hotspot input.

In an embodiment, method 400 can identify an activity based on the type or identity of the hotspot the user interacts with. In addition to edges or other bounding shapes, a given hotspot can be configured with a preconfigured type and, if necessary, parameters defining the hotspot relative to the type. For example, a hotspot for a trivia game can include a trivia type and an identifier of the game to play (or, optionally, a list of trivia questions to use for the game). Various types of activities can be launched, and some examples of such activities are described below.

In an embodiment, method 400 can launch a shopping activity. In some embodiments, hotspots can be generated around interesting objects or objects for sale within a video. In response to user input, method 400 can load additional detail regarding a given object (including additional similar or related objects) and can allow users to purchase the objects via the activity. In some embodiments, a user can pre-configured payment types (e.g., credit cards) to enable a one-tap purchasing of items via the activity.

Alternatively, or in conjunction with the foregoing, method 400 can launch a trivia activity in response to the user input. For example, the hotspot can be placed around a movie theatre marquee (with optional indicia calling out the marquee as interaction friendly). In such a scenario, the hotspot can be associated with a movie trivia activity. In some embodiments, the movie trivia activity can comprise a series of questions to be answered by the user of the fitness equipment. In some embodiments, the questions can be played over speakers communicatively coupled to the exercise bike. Alternatively, or in conjunction with the foregoing, the questions can be graphically displayed on a screen communicatively coupled to the exercise device. In some embodiments, the questions can take different forms, such as freeform answers, multiple-choice, true or false, etc. In some embodiments, a user can tap or type an answer on the screen to answer a question. In other embodiments, the user can speak the answer into a microphone communicatively coupled to the exercise device. In some embodiments, a speech-to-text process can be executed to convert the speech into a text answer, and then the question can be answered via the text.

In some embodiments, the video including a trivia activity can be simultaneously displayed to multiple geographically dispersed users. In some embodiments, since the video can be synchronized for all users (e.g., a fitness class), the hotspots will be displayed at the same and for the same duration for all users. In such a scenario, the trivia game can then be played with all users. In such a scenario, answers can be transmitted to the remote platform, and a multi-player score can be maintained. In some embodiments, when a user taps a hotspot in a group activity, the user can be added to a pool of users. Then, at a predetermined time, the activity can be initiated for all users in the pool. For example, the predetermined time may be the amount of time in which the hotspot is displayed.

Alternatively, or in conjunction with the foregoing, method 400 can launch a game activity in response to selecting a hotspot. No limit is placed on the type of games, and the type of games may vary based on the underlying type of exercise device. In some embodiments, the games may require manual input and thus may only be used on certain exercise devices (e.g., treadmills) that can be safely operated without the use of hands. In some embodiments, the games can be voice-controlled or may be controlled with a gamepad that is embedded in the exercise device. For example, a rower handle can include controls (e.g., a directional pad and one or more buttons) that can be used to play full-featured games while the user is exercising. In some embodiments, the games can comprise multi-player games.

Alternatively, or in conjunction with the foregoing, method 400 can launch a chat or other group messaging activity where users can interact with one another in response to touching a hotspot.

Alternatively, or in conjunction with the foregoing, method 400 can launch a tag mode or racing activity. In an embodiment, users participating in an activity can be graphically depicted in the video (e.g., either as avatars or in a leaderboard manner). In such an embodiment, each user can thus be associated with a hotspot. In some embodiments, when a given user selects another user's hotspot, a message can be sent to the other user indicating that the given user wishes to race the other user. In some embodiments, upon accepting, the displays of the racing users can be adjusted to only display data about the two users (i.e., removing all other users from the leaderboard or other display). In some embodiments, the race can be configured to last for a preconfigured length (e.g., one interval).

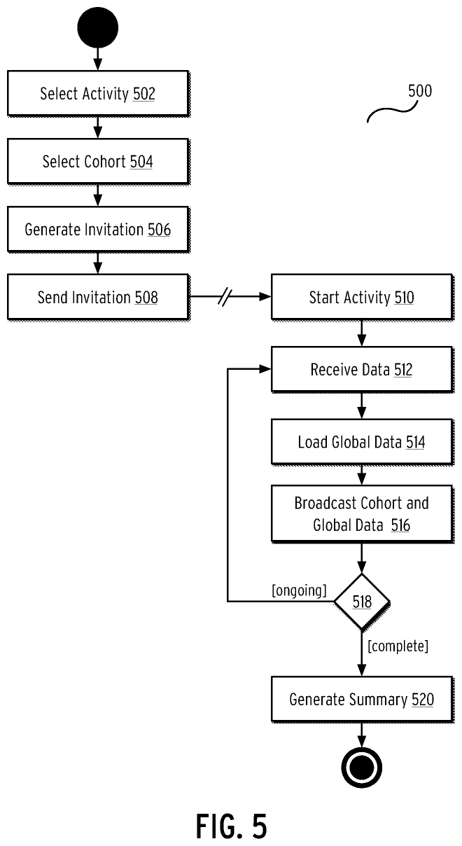

FIG. 5 is a flow diagram illustrating a method for generating a scheduled on-demand fitness activity according to some of the example embodiments.

In step 502, method 500 can include selecting an activity. In some embodiments, an activity can comprise a pre-recorded fitness class or similar type of physical activity using an exercise device. In some embodiments, the activity can include video content to play while being performed. In some embodiments, the activity can be selected from a list of on-demand fitness classes.

In step 504, method 500 can include selecting a cohort. In some embodiments, a cohort refers to a group of users of the same or similar types of exercise devices. In an embodiment, step 504 can include selecting a list of users from a user's list of friends. In other embodiments, step 504 can include selecting any list of users. In some embodiments, method 500 can require that all users in the cohort have the same type of exercise device. However, in other embodiments, disparate types of exercise devices.

In step 506, method 500 can include generating an invitation. In some embodiments, the invitation can include details of the selected activity and a plurality of fields entered by the user who selected the activity. For example, the user can select a future date and time to perform the selected activity. In some embodiments, the user can modify properties of the activity (e.g., target heart rates, resistance levels, etc.) as part of the invitation.

In step 508, method 500 can include sending the invitation to users in the cohort. In some embodiments, method 500 can send a text message, email message, or other forms of communication to all users in the cohort, notifying them of the proposed activity. In some embodiments, method 500 can receive acceptances or rejections of the invitation from the cohort. For acceptances, method 500 can store a list of those users that accepted the invitation in a database or similar data store for future use.

In step 510, method 500 can include starting the selected activity. As indicated by the broken arrow between step 508 and step 510, method 500 starts the selected activity at a future time.

In step 512, method 500 can include receiving data recorded during the selected activity. As described above, the selected activity can include a fitness class, and during the fitness class, a cohort of users may transmit performance data (e.g., distance, speed, elevation, cadence, split time, heart rate, etc.) to a remote platform. In step 512, the remote platform can receive this cohort data at regular intervals for a given activity.

In step 514, method 500 can include loading global data. In an embodiment, the global data can comprise previously recorded non-cohort data to the same activity when executed at a previous time. As described above, the activity selected in step 502 can comprise one or more existing on-demand classes. Thus, these on-demand classes may have been previously played back for multiple users, and performance data for the multiple users may have been collected, timestamped relative to the activity, and saved. Thus, in step 514, method 500 can identify the current timestamp of the selected activity and load all previous data from other users. In some embodiments, method 500 can filter out any data associated with members of the cohort.

In step 516, method 500 can include broadcasting cohort and global data.

In some embodiments, method 500 can aggregate or otherwise process the cohort and global data prior to broadcasting. In some embodiments, method 500 can broadcast data in a leaderboard format (or in a format amenable to creating a leaderboard). In an embodiment, an exercise device can receive the broadcast data and display a leaderboard for the selected activity.

In an embodiment, the exercise device can display two leaderboards simultaneously. In an embodiment, a first leaderboard can display a given user's position relative to only other users in the cohort. In an embodiment, a second leaderboard can display a given user's position relative to all global users (or a subset of the global users closest in the performance metric to the given user). In an embodiment, by providing both leaderboards, a given user can see their performance both as if they are riding in a global on-demand class as well as with respect to their cohort (e.g., a race within a race). Such an implementation is helpful for larger on-demand classes where the number of total users prevents a cohort from being identifiable within a larger leaderboard. Further, the use of a global leaderboard allows users to track their progress in a more holistic fashion rather than only providing cohort-level analysis.

In some embodiments, method 500 can display both leaderboards but only display one at a time. In such an embodiment, a toggle can be used to allow a user to switch between leaderboard types. In another embodiment, a leaderboard can always include cohort positions and can “fill” in empty space with global data to maintain a full-height leaderboard. In some embodiments, method 500 may only show a global leaderboard.

In step 518, method 500 can include determining if the fitness activity is ongoing. If so, method 500 can continuously update the leaderboards in the manner described with respect to step 512 through step 516. Once the activity ends, method 500 can then proceed to step 520.

In step 520, method 500 can include generating a summary of the activity. In an embodiment, method 500 can include displaying final leaderboards based on the recorded performance data. In some embodiments, method 500 can display a cohort summary leaderboard (displaying a given user's performance with respect only to the cohort data) and a global summary leaderboard (displaying a given user's performance with respect to all users for the activity).

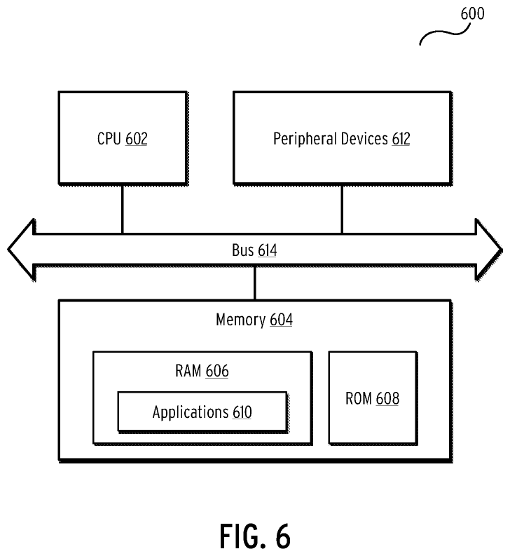

FIG. 6 is a block diagram of a computing device according to some embodiments of the disclosure.

As illustrated, the device 600 includes a processor or central processing unit (CPU) such as CPU 602 in communication with a memory 604 via a bus 614. The device also includes one or more input/output (I/O) or peripheral devices 612. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 602 may comprise a general-purpose CPU. The CPU 602 may comprise a single-core or multiple-core CPU. The CPU 602 may comprise a system-on-a-chip (SoC) or a similar embedded system. In some embodiments, a graphics processing unit (GPU) may be used in place of, or in combination with, a CPU 602. Memory 604 may comprise a non-transitory memory system including a dynamic random-access memory (DRAM), static random-access memory (SRAM), Flash (e.g., NAND Flash), or combinations thereof. In one embodiment, bus 614 may comprise a Peripheral Component Interconnect Express (PCIe) bus. In some embodiments, bus 614 may comprise multiple busses instead of a single bus.

Memory 604 illustrates an example of non-transitory computer storage media for the storage of information such as computer-readable instructions, data structures, program modules, or other data. Memory 604 can store a basic input/output system (BIOS) in read-only memory (ROM), such as ROM 608, for controlling the low-level operation of the device. The memory can also store an operating system in random-access memory (RAM) for controlling the operation of the device

Applications 610 may include computer-executable instructions which, when executed by the device, perform any of the methods (or portions of the methods) described previously in the description of the preceding Figures. In some embodiments, the software or programs implementing the method embodiments can be read from a hard disk drive (not illustrated) and temporarily stored in RAM 606 by CPU 602. CPU 602 may then read the software or data from RAM 606, process them, and store them in RAM 606 again.

The device may optionally communicate with a base station (not shown) or directly with another computing device. One or more network interfaces in peripheral devices 612 are sometimes referred to as a transceiver, transceiving device, or network interface card (NIC).

An audio interface in peripheral devices 612 produces and receives audio signals such as the sound of a human voice. For example, an audio interface may be coupled to a speaker and microphone (not shown) to enable telecommunication with others or generate an audio acknowledgment for some action. Displays in peripheral devices 612 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 612 may comprise any input device arranged to receive input from a user. An illuminator in peripheral devices 612 may provide a status indication or provide light. The device can also comprise an input/output interface in peripheral devices 612 for communication with external devices, using communication technologies, such as USB, infrared, Bluetooth™, or the like. A haptic interface in peripheral devices 612 provides tactile feedback to a user of the client device.

A GPS receiver in peripheral devices 612 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 6, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, can be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can, in fact, be executed substantially concurrently, or the blocks can sometimes be executed in the reverse order, depending upon the functionality or acts involved.

These computer program instructions can be provided to a processor of a general-purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure, a computer-readable medium (or computer-readable storage medium) stores computer data, which data can include computer program code or instructions that are executable by a computer, in machine-readable form. By way of example, and not limitation, a computer-readable medium may comprise computer-readable storage media for tangible or fixed storage of data or communication media for transient interpretation of code-containing signals. Computer-readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage, or other magnetic storage devices, or any other physical or material medium which can be used to tangibly store the desired information or data or instructions and which can be accessed by a computer or processor.

For the purposes of this disclosure, a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than or more than all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A method comprising:
reading performance data from an exercise device;
adjusting a visual output of one or more visual output devices (VODs) attached to a mechanical element of the exercise device; and
synchronizing the visual output of the one or more VODs in response to a change in the performance data.

2. The method of claim 1, wherein reading performance data comprises reading one or more of a speed, power, resistance, elevation, cadence, or split time.

3. The method of claim 1, wherein adjusting the visual output of the one or more VODs comprises categorizing the performance data and identifying an output value of the VODs based on a categorization of the performance data.

4. The method of claim 1, wherein adjusting the visual output of the one or more VODs comprises adjusting a brightness of the VODs.

5. The method of claim 1, wherein adjusting the visual output of the one or more VODs comprises adjusting a color of the VODs.

6. The method of claim 1, wherein adjusting the visual output of the one or more VODs comprises selectively adjusting the VODs to form a pattern.

7. The method of claim 1, wherein adjusting the visual output of the one or more VODs comprises toggling the VODs at a rate based on the performance data.

8. A method comprising:
loading a set of scenic activities, a given scenic activity in the set of scenic activities comprising a set of intervals, each interval in the set of intervals comprising a video segment and one or more parameters associated with an exercise device;
adjusting, by a user, an ordering of the set of scenic activities; and
adjusting, by the user, at least one parameter of at least one interval associated with a respective scenic activity in the set of scenic activities.

9. The method of claim 8, wherein the set of scenic activities include a set of video segments, the set of video segments obtained by segmenting a video a location.

10. The method of claim 8, wherein adjusting the ordering of the set of scenic activities one of adding, removing, or rearranging intervals in the scenic activity.

11. The method of claim 8, wherein adjusting the at least one parameter comprises adjusting one or more of a speed, power, resistance, elevation, cadence, or split time for the at least one interval.

12. The method of claim 8, further comprising playing back the set of intervals while the user operates the exercise device.

13. The method of claim 12, wherein playing back a given interval in the set of intervals comprises playing back a video segment associated with the given interval and adjusting the operation of a mechanical component of the exercise device based on a parameter associated with the given interval.

14. The method of claim 8, further comprising saving the adjusted set of scenic activities.

15. A method comprising:
displaying a video on a display of an exercise device, the video including a plurality of frames, at least one frame in the plurality of frames including a defined hotspot;
detecting that a user interacted with the defined hotspot while using the exercise device;
identifying an activity type based on the defined hotspot; and
launching the activity while the user uses the exercise device.

16. The method of claim 15, wherein the activity type comprises a shopping activity.

17. The method of claim 15, wherein the activity type comprises a trivia activity.

18. The method of claim 15, wherein the activity type comprises a game activity.

19. The method of claim 15, wherein the activity type comprises a racing activity.

20. The method of claim 15, wherein the activity type comprises a multi-player activity.

21. A method comprising:
initiating an on-demand fitness activity with a cohort of users;
recording performance data associated with each user in the cohort of users; and
generating a plurality of leaderboards based on the performance data, a first leaderboard in the plurality of leaderboards including the cohort of users and a second leaderboard in the plurality of leaderboards including a global set of users.

22. The method of claim 21, further comprising selecting the on-demand fitness activity and inviting one or more users to form the cohort of users.

23. The method of claim 21, wherein the global set of users comprises a set of users including users not in the cohort of users that have previously participated in the on-demand fitness activity.
